(19) United States
(12) Patent Application Publication
(10) Pub. No.: US 2022/0321944 A1
(43) Pub. Date: Oct. 6, 2022

(54) Augmenting Content Items

(71) Applicant: Comcast Cable Communications, LLC, Philadelphia, PA (US)

(72) Inventors: Mohammad Hosseini, Schaumburg, IL (US); Renxiang Li, Lake Zurich, IL (US); Isselmou Maloum, Lake In The Hills, IL (US); Ronald Lenk, Washington, DC (US)

(21) Appl. No.: 17/221,211

(22) Filed: Apr. 2, 2021

(51) Int. Cl. H04N 21/431; H04N 21/81; H04N 21/84

(52) U.S. Cl. CPC H04N 21/4316; H04N 21/8106; H04N 21/8126; H04N 21/816; H04N 21/84

(57) ABSTRACT

Systems, apparatuses, and methods are described for adding visual and/or sound effects to a content item to improve user experience. Addition of the visual and/or sound effects may be based on metadata associated with the content item.

### BACKGROUND

A content item (e.g., video and audio associated with an activity such as a sporting match) may be delivered to a user device. The user may be unsatisfied with the content item if it lacks images and/or sounds that the user expects to see and/or hear. For example, a user watching a football game may expect to see an audience appearing in the football stadium and to hear the audience cheering if there is a touchdown. However, sports and other activities may sometimes occur without a live audience (e.g., if large gatherings are discouraged during a pandemic) or without a full live audience. Video and/or audio from such an activity may be less enjoyable than might be the case if there were a live audience.

### SUMMARY

The following summary presents a simplified summary of certain features. The summary is not an extensive overview and is not intended to identify key or critical elements.

Systems, apparatuses, and methods are described for an augmented content item that includes visual effects and/or sound effects that may simulate image(s) and/or sound(s) that the user expects to see and/or hear. For example, the visual effects and/or sound effects may be added to a content item (e.g., an original or live content item). Modification of the content item may be based on metadata associated with the content item. For example, the content item may comprise a video stream of an activity without a live audience, and the activity may comprise an event such as a highlight. Metadata or other information may indicate a type of the event and an estimated level of reaction to the event such as an estimated excitement level associated with the event (e.g., an intensity level of audience reaction to the event). The visual effects may be added to the content item to simulate how a live audience may appear when responding to the event, and/or the sound effects may be added to the content item to simulate sounds that a live audience may make in response to the event. The visual effects and/or the sound effects may be based on metadata and/or other information associated with the content item.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an example of generating an augmented content item based on an original content item.

FIG. 4 shows an example of a system generating an augmented content item.

FIG. 5 shows an example of metadata that may be used to generate an augmented content item.

FIG. 6 is a flow chart showing an example method for generating an augmented content item.

### DETAILED DESCRIPTION

The accompanying drawings, which form a part hereof, show examples of the disclosure. It is to be understood that the examples shown in the drawings and/or described herein are non-exclusive and that there are other examples of how the disclosure may be practiced.

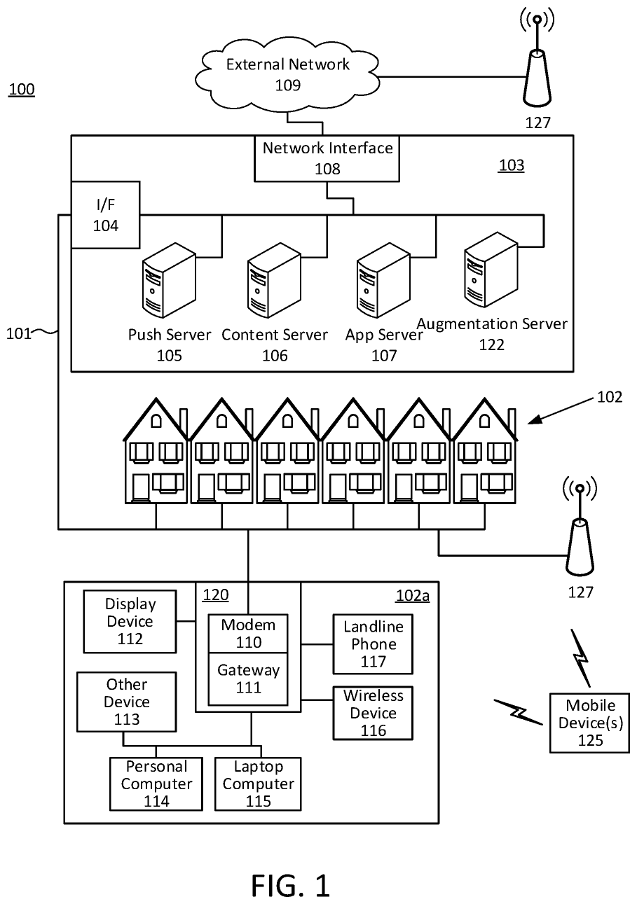

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content.

The content server 106 may provide one or more content items. Alternatively or in addition, content items may be provided from any other parts of the communication network 100, for example, from the external network 109. A content item may comprise a video, a video game, one or more images, software, audio, text, webpage(s), and/or other type of content. The content item may be a digital or analog data stream comprising video content (e.g., a sequence of video frames) and/or audio content associated with the video content. The content item may comprise a video stream of a sporting match (e.g., a football game, a basketball game, a baseball game, a gymnastics competition, a multi-sport competition (e.g., the Olympics), a race, etc.), an arts performance (e.g., a play, a concert, etc.), other types of activity (e.g., a parade, a speech, a legislative session, etc.), a movie and/or other type of entertainment, and/or any other content. The content item may be associated with a live activity (e.g., live coverage of sporting match, live coverage of an electronic sporting activity or game, live coverage of an on-stage performance, live news coverage, or live coverage of any other activity) and/or a recorded activity. For example, if the content item comprises coverage of a sporting match, the video content of the content item may comprise a sequence of video frames representing scenes of the sporting match, and audio content of the content item may represent sounds generated during the sporting match.

The content item may be associated with metadata. The metadata may comprise descriptive information of the content item. For example, the content item may comprise a video stream of an activity (e.g., sporting match such as a soccer game) without a live audience, and the content item may comprise one or more highlights and/or other events associated with the activity (e.g., game start, missed shots, yellow cards, red cards, goals, penalty kicks, end of first half, game end, national anthem, etc.). The metadata may indicate how visual effects and/or sound effects may be added to the content item to simulate audience images and/audience sounds. The metadata may indicate any general information about the content item (e.g., a content time length, an address of content source, etc.), descriptive information (e.g., activity information) associated with the content item (e.g., a content type of the content item such as activity type, a level associated with the content item such as activity level, a location associated with the content item such as an activity location, etc.), event information including any information associated with the highlights or other events in the content item (e.g., event types, estimated excitement levels, event timestamps, etc.), video content information including any information associated with the video frames (e.g., camera information associated with stadium cameras capturing images of the video frames, etc.), audio content information including any information associated with the audio content (e.g., audio channel information, etc.), and/or any other information associated with the content item. The metadata may be used to generate the augmented content item by adding visual effects and/or sound effects to the content item.

The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as an augmentation server 122 (described below), additional push, content, and/or application servers, and/or other types of servers.

The augmentation server 122 may modify a content item (e.g., by adding visual effects and/or sound effects to the content item) to generate an augmented content item. For example, a content item may comprise a video stream of a football game without a live audience. The augmentation server 122 may add simulated audience images (e.g., images of sports fans leaving their seats to celebrate a touchdown) and/or audio content representing simulated sounds made by an audience (e.g., sounds of sports fans cheering, sounds of sports fans booing, etc.) to the content item to generate the augmented content item. When the augmented content item is presented to the user, the user may see simulated audience images and/or hear simulated audience sounds. With the simulated audience images and sounds, the user may feel more involved while watching the game. As such, the user experience is improved.

Although shown separately, the push server 105, the content server 106, the application server 107, the augmentation server 122, and/or other server(s) may be combined. The servers 105, 106, 107, and 122, and/or other servers, may be computing devices and may comprise memory storing data and also storing computer executable instructions that, when executed by one or more processors, cause the server(s) to perform steps described herein. One or more of the servers 105, 106, 107, and 122, and/or other servers, may also or alternatively be located at other local offices and/or in the external network 109.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions, VR (virtual reality) headset), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol—VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content. The mobile devices 125, one or more of the devices in the premises 102a, and/or other devices may receive, store, output, and/or otherwise use content items available via the communication network 100.

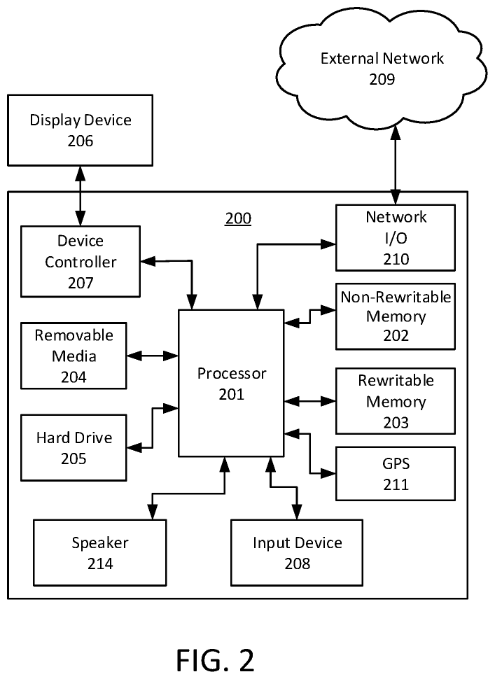

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices described herein (e.g., the augmentation server 122). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 described above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

A content item may be available via the communication network 100, and may be delivered to one or more user devices (e.g., one or more mobile devices 125, one or more of the devices in the premises 102a, and/or other devices) for a user to consume. The user may have certain expectations during consumption of a content item. If the content item does not meet user's expectations, the user may feel disappointed and unsatisfied. For example, a user watching a sporting match on a user device may expect to see an audience and/or to hear sounds made by an audience. Such expectations may not be met if the sporting match takes place without a live audience. If there is no live audience on the scene, the content item comprising the sporting match may not comprise data representing images of an audience and/or data representing sounds of an audience. A silent and/or empty stadium throughout a game may seem awkward and/or otherwise provide an unsatisfying user experience.

To improve the user experience, the augmentation server 122 may simulate audience images (e.g., images of audience) and audience sound (e.g., sounds made by an audience) that are missing in the original content item. For example, the augmentation server 122 may generate an augmented content item, for the user to consume, by adding visual and/or sound effects (representing the simulated audience images and simulated audience sounds) to the original content item.

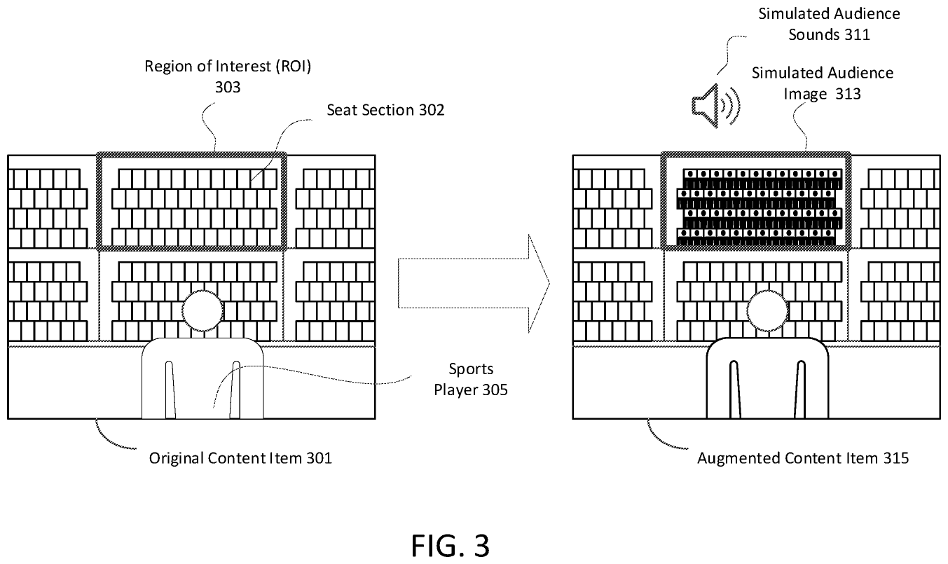

FIG. 3 shows an example of generating an augmented content item based on an original content item. The original content item 301 may comprise video and/or audio associated with an activity (e.g., a sporting match such as a soccer game that takes place in a nearly empty stadium without a live audience). The video of the original content item 301 may comprise images of one or more sports players 305, images of other game participants such as referees and game assistants, images of one or more empty seat sections 302 of the stadium, etc. The audio of the original content item 301 may include audio of sounds made by the sports players 305, audio of sounds made by other game participants during the game, etc. However, the video of the original content item 301 may lack audience images, and/or audio of the original content item 301 may lack audience sounds. To simulate audience images and audience sounds, visual effects (comprising a simulated audience image 313) and/or sound effects (comprising simulated audience sounds 311) may be added to the original content item 301, thereby generating the augmented content item 315.

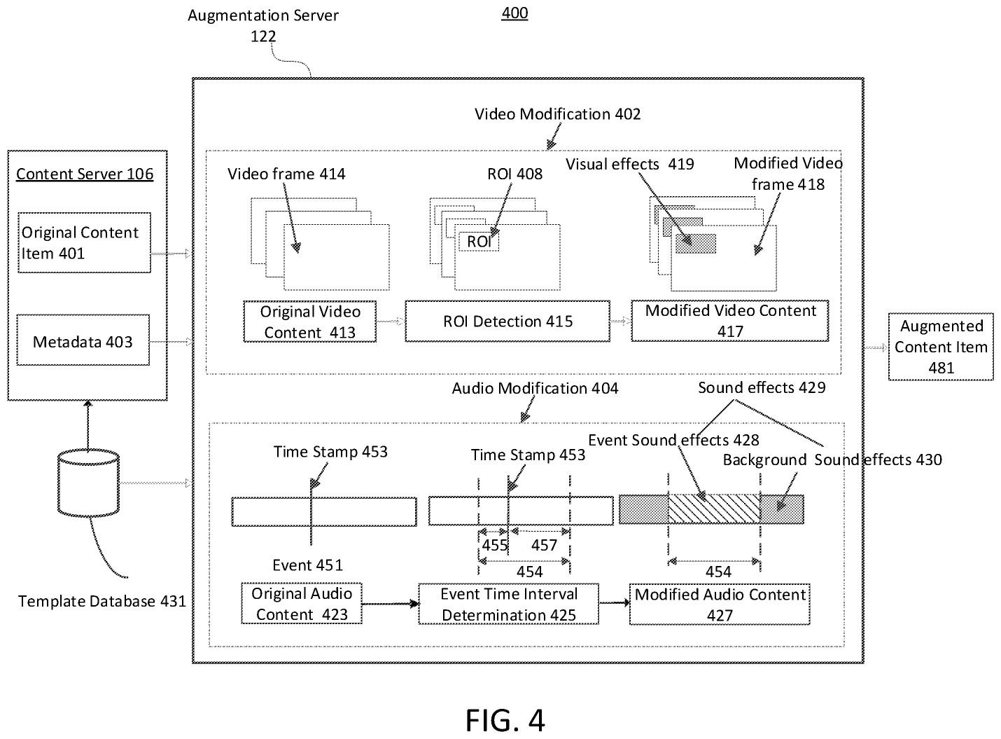

The video of the original content item 301 may comprise a sequence of video frames. The simulated audience image 313 may be added to one or more of the video frames. A video frame may comprise an image generated by a camera, a recorder, or any device that may capture an image. For example, a video frame of the original content item 301 may be generated by a stadium camera (a camera installed in the stadium at which the soccer game takes place) that is configured at a camera setting (e.g., a camera height, a camera angle, a zoom reading, etc.). The video frame may comprise a region of interest (ROI) 303. The ROI 303 may be a target region, of the video frame, to which the simulated audience image 313 will be added. For example, the ROI 303 may correspond to an empty seat section 302 of the stadium. If the video frame comprises one or more empty seat sections, the video frame may comprise one or more ROIs 303. If the video frame does not comprise any empty seat section, the video frame may not be associated with an ROI. The ROI 303 may be determined based on information (e.g., camera information of the stadium camera generating the video frame) included in metadata associated with the original content item 301. Alternatively or in addition, the ROI 303 may be determined based on object detection and/or any other methods that may determine an ROI. Determination of the ROI 303 is further described in connection with FIG. 4.

The simulated audience image 313 may be added to the ROI 303 to simulate how sports fans in the seat section 302 would appear, if there were sports fans on the scene. The simulated audience image 313 may be a past image that was previously captured during a past activity with a live audience. For example, if the video frame comprises an image showing that the sports player 305 is making a goal in the stadium, the simulated audience image 313 may be a past image, of a past audience, captured during a past goal made by the sports player 305 in the same stadium. The past image may be selected to simulate how a live audience would react to the current goal based on a prediction that, if the current soccer game had an audience, audience reactions to the current goal would be similar to the past audience reactions to the past goal. The image of empty seat section 302 in the ROI 303 may be replaced or covered by the simulated audience image 313. The original content item 301 may comprise a plurality of video frames, and visual effects may be added to one or more video frames, of the plurality of video frames, that include one or more ROIs such as the ROI 303.

Audio of the simulated audience sounds 311 may be added to the audio of the original content item 301 to simulate audience sounds. To simulate audience sounds in response to a highlight (e.g., a goal) or other event, for example, audio of the simulated audience sounds 311 may be added to a portion of the original content item 301 audio that corresponds to an event time interval (described below) associated with the event. A event time interval may comprise a time period before and/or a time period after a time associated with a highlight and/or an event (and/or with a specific occurrence or occurrences during that highlight or other event). For example, an audience may start cheering based on a player preparing for a goal, and may continue to cheer for a certain time period after the goal has occurred. The event time interval may correspond to a time interval starting from the time point at which an audience starts reacting prior to occurrence of the goal to the time point at which the audience stops cheering the goal.

An event time interval may be determined based on historical data that indicates how long audiences responded to similar events in the past. For example, a current soccer game may take place between Team 1 and Team 2 and in Team 1's home stadium, and a current goal made by Team 1 may occur at 01:05:02 (e.g., 1 hour, 5 minutes, 2 seconds) of the soccer game. The historical data may indicate that, for the past goals made by Team 1 in the past soccer games between Team 1 and Team 2, in Team 1's home stadium, and during a game time range that includes 01:05:02 on a game clock, past live audiences started to respond to the past goals an average time period of 5 seconds before the past goals actually occurred and continued to cheer the past goals for an average time period of 1 minute after the past goals had occurred. The event time interval for the current goal may be determined to be 1 minute and 5 seconds, which starts from 5 seconds prior to the current goal and ends at 1 minute after the current goal.

Audio of the simulated audience sounds 311 may be a sound recording that was previously recorded in a past activity with a live audience. For example, the audio of the simulated audience sounds 311 may comprise a sound recording that was previously recorded during a past goal (made by Team 1) in a past soccer game (between Team 1 and Team 2) taking place in Team 1's home stadium. The sound recording from the past goal may be selected to simulate sounds that an audience would make in response to the current goal based on a prediction that, if the current soccer game had an audience, audience reactions to the current goal would be similar to the past audience reactions to the past goal. By augmenting the audio of the original content item using audio from the sound recording from the past goal, sound effects may be added to simulate the audience reactions to the current goal.

If an activity has multiple highlights and/or other events, audio effects may be added to multiple portions of the original content item 301 audio corresponding to multiple event time intervals associated with the multiple events. Even when there is no event, an audience may still make some background noise (e.g., chatting sound). Sound effects simulating background noise may be added to one or more portions of audio content of the original content item 301. The augmented content item 315 may comprise the visual effects that simulate the audience images and/or sound effects that simulate audience sounds in response to events and/or background noise. During consumption of the augmented content item 315, a user experience may be improved based on seeing a simulated audience and hearing simulated audience sounds.

FIG. 4 shows an example of a system generating an augmented content item. A system 400 may modify an original content item 401 to generate an augmented content item 481. The system 400 may comprise the content server 106, the augmentation server 122, and a template database 431. For convenience, the description of FIG. 4 refers to operations performed by the content server 106, operations performed by the augmentation server 122, and operations performed by the template database 431. However, any operation described as performed by one device in FIG. 4 could also or alternatively be performed, in whole or in part, by another device in FIG. 4 and/or by another computing device not shown in FIG. 4.

The template database 431 may, for example, comprise a computing device configured to maintain one or more databases and/or otherwise store and/or provide access to ROI templates, visual templates, audio templates, and/or any other templates that may be used to generate the augmented content item 481, and any information associated with these templates. The templates and their corresponding information are further described below. The template database 431 may be located in a local office (e.g., the local office 103) and/or in the external network 109.

The content server 106 may provide (e.g., send) the original content item 401 and metadata 403 associated with the original content item 401 to the augmentation server 122. The original content item 401 may be similar to the content item 301. The original content item 401 may comprise original video content 413 and original audio content 423. The original video content 413 may comprise one or more video frames 414. The original audio content 423 may be associated with the original video content 413. A portion of the original audio content 423 may comprise sounds occurring during scenes that are comprised by corresponding video frames 414. For example, the original content item 401 may comprise an activity without a live audience (e.g., a soccer game taking place in a nearly empty stadium). One or more of the video frames 414 may represent a player making a goal, and a corresponding portion of the original audio content 423 may represent sounds during the time period that the player is making the goal.

The augmentation server 122 may process the original content item 401, and add visual effects 419 and sound effects 429 to the original content item 401 to simulate audience images and audience sounds. Alternatively or in addition, any other component (e.g., a user device such as a mobile device 125, a device in the premises 102a, etc.) in the network 100 may process the original content item 401, and add visual effects 419 and/or sound effects 429 to the original content item 401.

The augmentation server 122 may perform a video modification 402 for the original video content 413. The augmentation server 122 may extract the original audio content 423 from the original content item 401 and may perform an audio modification 404 for the extracted original audio content 423. The augmentation server 122 may perform the video modification 402 and the audio modification 404 in parallel, serially, and/or in any order.

The augmentation server 122 may (e.g., as part of the video modification 402) perform an ROI detection 415 to determine if the video frame 414 comprises an ROI 408. The ROI 408 may be similar to the ROI 303, and may correspond to an empty seat section. If the video frame 414 comprises an ROI 408, the visual effects 419 may be added to the video frame 414. For example, the visual effects 419 may be added to the ROI 408. If a video frame does not comprise an ROI, visual effects may not be added to the video frame.

The ROI 408 may be determined based on the metadata 403. For example, the ROI 408 may be determined by comparing camera information (included in the metadata 403) associated with the video frame 414 to one or more ROI templates stored in the template database 431.

An ROI template may comprise data indicating a particular camera at a particular location (e.g., a particular stadium); data indicating a particular group of settings for that camera (e.g., a position, pan/tilt, zoom, resolution, etc.); data indicating one or more ROIs in an image captured by the camera with those settings; and/or any other data related to the one or more ROIs. Alternatively or in addition, an ROI template may comprise data indicating objects to which the one or more ROIs correspond (e.g., an empty seat section, part of an empty seat section, etc.); shape(s) of the one or more ROIs (e.g., a rectangle); size(s) of the one or more ROIs (e.g., W pixels×L pixels); relative portion(s) of the one or more ROIs (e.g., coordinates (x, y)); etc.

If the ROI 408 corresponds to an empty seat section, for example, one or more associated ROI templates may comprise information for determining a seat section in the video frame 414. For example, a seat section may have a fixed shape, a fixed size, and/or a fixed location with respect to the stadium. Based on information associated with settings of a camera capturing an image in the stadium (e.g., camera position, pan angle, tilt angle, zoom, resolution (e.g., pixel count), etc.), the portion of the captured image corresponding to the seat section (or a portion thereof) may be determined. If images captured by a stadium camera configured at a camera settings include the seat section (or a portion thereof), a corresponding ROI template may be used to determine the location of the seat section on the images captured by the stadium camera configured at the camera settings. If images captured by a stadium camera configured at a camera setting do not include a seat section, no ROI template may be available for these images. If the video frame 414 includes a seat section, a corresponding ROI template may be found to locate the seat section in the image of the video frame 414, thereby determining the ROI 408 for the video frame 414. If the video frame 414 does not include a seat section, no ROI template may be found, thereby determining that the video frame 414 does not include an ROI 408.

For example, an ROI template may indicate that, in any image captured by camera #3 configured at camera settings #5 (e.g., representing a particular combination of camera position, pan angle, tilt angle, zoom, etc.), a portion of the image representing a seat section A may have a shape of rectangle, a size of W pixels×L pixels, and a location in the image (e.g., based on pixel distance(s) within the image). The relative location may, for example, be coordinates (x, y) indicating that a left top corner of the seat section A rectangle is located x pixels to the right of, and y pixels above, a left bottom corner of the image. Accordingly, the ROI template may comprise: a shape of rectangle; a size of W pixels×L pixels, a relative location (x, y), and camera information (e.g., camera #3 configured at camera settings #5). If the seat sections are rearranged or the stadium cameras are reinstalled, the ROI templates may be updated.

The video frame 414 may comprise an image that is captured by a stadium camera configured at camera settings. A portion of the metadata 403 associated with the video frame 414 may comprise camera information that indicates a particular stadium camera used to capture an image of the video frame 414 and settings for that camera at the time of image capture.

The augmentation server 122 may determine the camera information associated with the video frame 414 from the metadata 403, and may compare the camera information associated with the video frame 414 to camera information associated with one or more ROI templates. Based on that comparison, the augmentation server 122 may determine if there is a corresponding ROI template (e.g., an ROI template comprising data matching some or all of the camera information). Based on determining a corresponding ROI template, the augmentation server 122 may determine that the video frame 414 includes the ROI 408. The size of the ROI 408, shape of the ROI 408, relative location of the ROI 408 in the video frame 414, and/or other information about the ROI may correspond to the size indicated by the corresponding ROI template, the shape indicated by the corresponding ROI template, the relative location indicated by the corresponding ROI template, respectively. If it is determined that none of the ROI templates comprise data matching the camera information associated with the video frame 414, the augmentation server 122 may determine that the video frame does not have an ROI 408.

Alternatively or in addition, the content server 106 may compare the camera information associated with the video frame 414 to camera information associated with one or more ROI templates, and may predetermine the size of the ROI 408, shape of the ROI 408, relative location of the ROI 408 in the video frame 414. The content server 106 may include corresponding information about the predetermined size of the ROI 408, predetermined shape of the ROI 408, predetermined relative location of the ROI 408 in the metadata 403. The augmentation server 122 may determine the information about the predetermined size of the ROI 408, predetermined shape of the ROI 408, predetermined relative location of the ROI 408, and may determine size of the ROI 408, shape of the ROI 408, relative location of the ROI 408 based on the determined information.

Alternatively or in addition, the ROI 408 may be determined using object detection. For example, the augmentation server 122 may determine the ROI 408 by comparing the image of the video frame 414 to one or more reference geometric patterns. The shapes and sizes of the geometric patterns may correspond to shapes and sizes of seat sections in the past images. The augmentation server 122 may compare the image of the video frame 414 to the reference geometric patterns. If an object of the video frame 414 has a similar size and shape as a reference geometric pattern, the augmentation server 122 may determine that the video frame 414 has an ROI 408 that corresponds to the object. The size and shape of the ROI 408 may be the size and shape of the matched geometric pattern. The ROI location of the ROI 408 may be determined based on the relative location of the object, that matches the matched geometric pattern, within the video frame 414. If no match is found, it may be determined that the video frame 414 does not have an ROI 408.

If a video frame does not have an ROI, the augmentation server 122 may determine that the visual effects will not be added to the video frame. For example, a video frame may only include an image showing a soccer ball rolling on the grass field and/or may otherwise not comprise a portion associated with an audience. If a video frame is determined to comprise an ROI, the augmentation server 122 may modify the video frame by adding visual effects to that ROI, thereby generating a modified video frame.

For example, based on determining that the video frame 414 comprises the ROI 408, the augmentation server 122 may generate the modified video frame 418 by adding the visual effects 419 to the ROI 408. The augmentation server 122 may, for example, replace or cover the image of the empty seat section in the ROI 408 with an image showing a seat section occupied by sports fans. If the seat section in the ROI 408 is blocked by foreground objects such as sports players, the augmentation server 122 may detect the foreground objects, extract the foreground objects from the video frame 414, add the visual effects 419 to the ROI 408, and then overlay the extracted foreground objects over the visual effects 419.

Visual effects added to a video frame (e.g., the visual effects 419 added to the video frame 414) may comprise past images captured during past activities, animated characters, videos provided via online video sessions, or any other video/image content. For example, if the video frame 414 is associated with a soccer game without a live audience, the visual effects 419 may comprise a past image, of an audience, captured during a past soccer game.

An event in a content item (e.g., a highlight) may be associated with different levels of reactions. For example, a level of reaction to an event may comprise a quantification, prediction, and/or other indication of one or more of: an excitement level associated with that event, an emotion level associated with that event, a noise level associated with that event, a movement level associated with that event, a lighting level associated with that event, and/or any other occurrence, state, condition, etc. that may happen at or near the time of that event. Although the term “reaction” is used for convenience, a reaction or level of reaction associated with an event need not be directly or indirectly caused by that event. A reaction or level of reaction may, but need not necessarily be, associated with an audience.

An excitement level may, for example, quantify, predict, and/or otherwise indicate an intensity level of audience reaction to an event. An excitement level of an event may vary based on any information related to the event (e.g., event type, information about an event maker (e.g., a person or persons causing the event), event timestamp, content type of content item, activity level and/or priority associated with content item (e.g., whether a sports match is a championship match), participant information associated with content item, location information associated with content item, audience information, weather information, time associated with the content item, etc.). An emotion level may, for example, quantify, predict, and/or otherwise indicate how emotional an audience may be during an event and may vary based on any information related to the event.

The visual effects 419 may, for example, be determined based on an estimation of a reaction (e.g., by or otherwise associated with an audience) to the scene associated with the video frame 414. For example, if the video frame 414 is associated with an event such as a highlight (e.g., a goal), the visual effects 419 may represent that a majority of the audience in the ROI 408 leave their seats and wave their arms. If the video frame 414 is not associated with an event (e.g., the image of the video frame 414 does not represent a scene associated with an event), the visual effects 419 may represent that audience in the ROI 408 sit on their seats and talk to each other.

Different events may be associated with different levels of reactions. For example, the excitement level of an event may vary depending on the event type of the highlight. An audience may get more excited for a goal than for a missed shot. Accordingly, the excitement level of a goal may be higher than the excitement level of the missed shot. As another example, the excitement level may depend on a timestamp of the event. The timestamp may indicate a time at which the event occurs. A last-minute goal may be associated with a higher excitement level than a goal occurring at the middle part of the game. As another example, the excitement level may depend on who makes (e.g., causes) the event. A goal made by a more popular sports player may be associated with a higher excitement level than a goal made by a less popular sports player.

The excitement level of the event may comprise any indicator that may differentiate one intensity level of audience reaction from another intensity level of audience reaction. For example, the excitement level may be a numerical digit (e.g., 40 for a passing, 100 for a goal), a percentage (e.g., 40% for a passing, 100% for a goal), a level gradient (e.g., medium for a passing, high for a goal), etc.

The excitement level may comprise a range of values. As described above, an event may be associated with an event time interval that indicates how long an audience may respond to the event. The excitement level may be a range corresponding to the event time interval. For example, a goal may be associated with an event time interval of 1 minute and 5 seconds. The excitement level of the goal may be a range of 50-100-50, which increases from 50 (e.g., for an audience starting getting excited at the beginning of the event time interval) to 100 (e.g., for an audience getting more and more excited, and being the most excited at the timestamp of the goal) and then decreases to 50 (e.g., for an audience calming down until the end of the event time interval).

A level of reaction of an event of an activity without a live audience may be an estimated level of reaction. For example, an excitement level of an event of an activity without a live audience may be an estimated excitement level for the event. The estimated excitement level for the event may predict how excited an audience, if present, would be in response to the event. The augmentation server 122 may determine the estimated excitement level for the event based on historical data and/or any activity and/or event information included in the metadata 403. For example, the activity and/or event information in the metadata 403 may indicate that the current event is a goal made by Team 1 in a soccer game taking place at Team 1's home stadium. If historical data indicates that an average excitement level of the past goals made by Team 1 in soccer games taking place at Team 1's home stadium is 100 and an average excitement level of the past goals made by Team 1 in soccer games taking place away from Team 1's home stadium is 75, the augmentation server 122 may determine that the estimated excitement level of the current goal is 100 based on the current goal taking place at Team 1's home stadium.

The video frame 414 may be associated with an event, for example, if a timestamp of the video frame 414 is the same as a timestamp of an event or falls within an event time interval of an event. If the video frame 414 is associated with an event, the augmentation server 122 may associate the video frame 414 with an estimated excitement level corresponding to the estimated excitement level for the event. For example, the estimated excitement level for the video frame 414 may be the estimated excitement level for the event. If the estimated excitement level for the event is a range of values, the estimated excitement level for the video frame 414 may be any value of the range of values, the highest value of the range, an average value of the range, or a value within the range that corresponds to a timestamp of the video frame 414.

For example, a timestamp of the video frame 414 may indicate that the video frame 414 is part of a scene in which a player is kicking the ball towards the goal but the ball has not been kicked into the goal. If the range of the estimated excitement level for the goal is a range of 50-100-50, the video frame 414 may be associated with a value of between 50 and 100 (e.g., 90) because the audience may already be very excited but has not yet reached the most excited point of 100. If the video frame 414 is not associated with an event, for example, the augmentation server 122 may determine that the video frame 414 does not need to be associated with an estimated excitement level, or may assign the video frame 414 with an estimated excitement level indicating that the video frame 414 is not associated with an event.

Alternatively or in addition, the content server 106 may predetermine the estimated excitement level for the event and the estimated excitement level for the video frame 414 based on historical data and/or any activity and/or event information included in the metadata 403, and may include corresponding information about the predetermined estimated excitement levels in the metadata 403. For example, the metadata 403 may indicate that the estimated excitement level for the goal is a predetermined value of 100, and the estimated excitement level of the video frame is a predetermined value of 100. The augmentation server 122 may determine the information about the predetermined estimated excitement level for the event and the predetermined estimated excitement level for the video frame 414, and may determine the estimated excitement level for the event and the estimated excitement level for the video frame 414 based on the determined information.

The template database 431 may store one or more visual templates for generating the visual effects 419. The visual templates may comprise past images captured during past activities, animated characters, videos provided via online video sessions, or any other video/image content. The augmentation server 122 may select one or more visual templates that may best simulate audience reactions to the scene of the video frame 414, and may fit the selected one or more visual templates into one or more ROIs 408, e.g., by replacing or covering the images of one or more ROIs 408 with the selected one or more visual templates.

A visual template may, for example, comprise a portion of an original past image that shows an occupied seat section during a past sporting match. The visual template may show audience appearance in the occupied seat section. The visual template may be associated with camera information (e.g., camera identification, camera setting(s)) of a stadium camera capturing the past image, descriptive information associated with the content item associated with the past activity, event information associated with the past image, an excitement level associated with the past image, etc. For example, if the past image was captured during a past goal, the visual template may be associated with an event type of the past goal, and the excitement level associated with the visual template corresponds to the excitement level of the past goal.

The augmentation server 122 may compare information from one or more portions of the metadata 403, associated with the video frame 414, to information of visual templates. Based on that comparison, the augmentation server 122 may determine a visual template to add into the ROI 408. For example, based on an estimated excitement level for the video frame 414, the augmentation server 122 may select an event visual template that is associated with an excitement level closest to the estimated excitement level for the video frame 414.

Alternatively or in addition, the augmentation server 122 may prioritize information included in the metadata 403 (e.g., activity information, event information, video content information, etc.), and select a visual template based on a priority order of the information. For example, an audience may dress differently for different types of activities (e.g., soccer sports fans wearing shirts with a soccer team color, baseball sports fans wearing shirts with a different baseball team color). If it is determined that the best way to improve the user viewing experience is to let the user see an audience wearing appropriate attire (e.g., team colors), it may be determined that the type of the activity is the most critical information for selecting a right visual template.

The event type may also/alternatively be a basis for determining a visual template. For example, people may make different body movements and/or facial expressions in response to different types of events, e.g., cheering appearance for goals and booing appearance for red cards. The event type may be considered as the second critical information, because it may be also important for the user to see a simulated audience making body movements and/or facial expressions appropriate for an event.

The estimated excitement level may be determined as the third critical information, as it may be also important for the user to see the simulated audience reacting to the scene at a proper intensity level. Other information may be also assigned with corresponding priority orders, and/or the priorities assigned to activity type, event type, and/or excitement level may be other than those in the above examples.

Priorities assigned to and/or otherwise associated with activity type, event type, excitement level, and/or other information may be used to select and/or otherwise determine visual templates. The augmentation server 122 may identify, from visual templates stored in the template database 431, one or more visual templates associated with the same or similar activity type as the video frame 414. For example, ten (or some other quantity of) visual templates associated with the same activity type may be identified. Among the ten identified visual templates, the augmentation server 122 may further narrow down the pool of visual templates by selecting visual template(s) associated with the same or similar event type as the video frame 414.

If none of the ten visual templates is associated with the same event type as the video frame 414, for example, the augmentation server 122 may select one or more visual templates associated with an event type similar to the event type associated with the video frame 414. For example, the video frame 414 may represent an event of red card. If none of the ten visual templates is associated with red card, the augmentation server 122 may select, from the ten visual templates, one or more visual templates associated with other similar event types (e.g., referee making other calls, such as a yellow card, that the audience disagrees with) because the audience may react to the other calls in a manner similar to how the audience may react to a red card (although possibly at a different excitement level).

The augmentation server 122 may further narrow down the pool of visual templates by selecting, from the remaining visual templates, one or more visual templates associated with excitement level(s) that are the same as or similar to the estimated excitement level associated with the video frame 414. If none of the remaining templates are associated with excitement level(s) ate the same as or similar to the estimated excitement level associated with the video frame 414, the augmentation server 122 may select one or more templates, from the remaining visual templates, with an excitement level closest to the estimated excitement level associated with the video frame 414. The augmentation server 122 may then continue to narrow down the pool based on other information in the priority order, until a match or a best visual template is found.

The priority order should not be limited to the order described above, and may be any order. The priority order may be adjusted based on user feedback. For example, the user feedback may indicate that seeing the audience making appropriate body movements is more important than seeing the audience wearing appropriate colors, and the augmentation server 122 may adjust the priority order, e.g., assigning the event type a higher priority than the activity type.

Alternatively or in addition, each type of the information of a visual template may be assigned or otherwise associated with a weight, and the selection of a visual template may be based on a weight function. For example, the information of a visual template may comprise activity type, event type, camera setting, etc. and associated respective weights. Weights may be assigned, for example, based on one or more determinations of which information is more critical for determining a visual template.

The activity type, event type, camera setting(s), and/or other information of a visual template may be compared to the activity type, event type, camera setting(s), and/or other information of the video frame 414. A similarity score may be determined based on the comparison. For example, a similarity score of 1 may be assigned to a matching, a similarity score of 0.5 may be assigned to a partial matching, and a similarity score of 0 may be assigned to no matching.

For example, a matching may be determined based on the event type associated with a visual template being a red card and the event type associated with the video frame 414 also being a red card, which may result in a similarity score of 1 for the comparison between event types. As another example, a partial matching may be determined based on the event type associated with a visual template being a red card and the event type associated with the video frame 414 being yellow card, which may result in a similarity score of 0.5 for the comparison between event types. This may be because the audience would make similar sounds and body movements and/or facial expressions for red card and yellow card (although possibly at a different excitement level). Still as another example, a no matching may be determined based on the event type associated with the visual template being a red card and the event type associated with the video frame being a goal, which may result in a similarity score of 0 for the comparison between highlight types. This may be because the audience may appear and sound very differently in these two different types of events (e.g., cheering for goal, booing for red card). Even though the above examples show 3 levels of similarity (e.g., matching, partial matching, no matching), similarity scores may have any number of levels. A similarity score may be any value or any range of values that may differentiate levels of similarity.

A weighted sum may be determined based similarity scores and weights associated with various types of information. For example, the activity type may be considered critical and has a weight of 20, the event type may be considered less critical and have a weight of 15, and the camera setting may have a weight of 5. The comparison result for the activity type may be a matching (e.g., a similarity score of 1), the comparison for the event type may be a partial matching (e.g., a similarity score of 0.5), and the comparison result for the camera setting may be no matching (e.g., a similarity score of 0). In this example, the weighted sum may be 27.5, which may be calculated by: [20 (weight of activity type)×1 (similarity score of comparison result for activity type)]+[15 (weight of event type)×0.5 (similarity score of comparison result for event type)]+[5 (weight of camera setting)×0 (similarity score of comparison result for camera setting)]. Because a higher weighted sum indicates higher similarity between a scene represented by a visual template and the scene represented by the video frame 414, the augmentation server 122 may select the visual template having the highest weighted sum for determining a visual template.

If all the information of the selected visual template matches the information of the video frame 414, for example, the selected visual template may represent audience reaction to a same scene as the video frame 414, and thus may be sufficient for simulating audience appearance for the video frame 414. The augmentation server 122 may replace or cover the image of the ROI 408 with the selected visual template.

If there is no matching template, for example, the augmentation server 122 may select a best visual template (e.g., a past image) that has information closest to that of the video frame 414. Because there still may be differences between the information of the selected best visual template and the information of the video frame 414, the selected best visual template may represent audience reaction to a different scene as the video frame 414. To compensate for at least part of the difference, the selected best visual template may be modified before being added to the ROI 408. For example, the metadata 403 may indicate that it is raining at the scene represented by the video frame 414. The video frame 414 may comprise rain drops. However, the selected visual template may be associated with a sunny day and may not show rain drops. If the selected visual template is added to the ROI 408 without modification, the visual effects provided by the selected visual template may be inconsistent with other regions of the video frame 414. To improve the quality of the augmented content item 481, the augmentation server 122 may modify the selected visual template by using a filter add haze similar to rain drops, by adding animated rain drops, and/or in other ways to make modified selected visual template more consistent with other regions of the video frame 414.

As another example, the selected visual template may have an excitement level different from the estimated excitement level associated with the video frame 414. For example, the excitement level of the selected visual template may be lower than the estimated excitement level associated with the video frame 414. An audience may make more exaggerated body movements (e.g., higher motions, higher jumps, etc.) in response to a more exciting scene. To match the higher estimated excitement level for the video frame 414, the augmentation server 122 may modify audience images included in the selected visual template such that the modified audience images may represent a simulated audience making higher motions and/or higher jumps.

As another example, the selected visual template may be associated with different activity location information compared to the video frame 414. The selected visual template may show a simulated audience doing certain dance moves (and/or waving arms in certain ways) that generally do not occur in the geographical area associated with the video frame 414. The augmentation server 122 may modify audience images included in the selected visual template such that the modified audience images may represent a simulated audience doing proper dance moves (and/or waving arms in proper ways) that are traditional in the geographical area associated with the video frame 414.

As another example, the selected visual template may have a different size and/or shape compared to the ROI 408. The augmentation server 122 may resize, crop, and/or reshape the visual template (e.g., using image scaling, image warping, perspective transform, etc.) such that the visual template may be fit into the scaled visual template into the ROI 408.

As another example, the selected visual template may have different foreground and/or background compared to the image of ROI 408. The augmentation server 122 may use depth analysis to detect foreground and/or background objects for the selected visual template and the image of the ROI 408. For example, it may be determined that the selected visual template shows an empty seat section that is partially obstructed by a foreground object such as a light pole, and the image of the ROI 408 shows an empty seat section that is not obstructed by anything. The augmentation server 122 may modify the selected visual template (e.g., by image masking) to remove the foreground object from the past image so that the modified selected visual template may be more consistent with other parts of the video frame 414. As another example, the selected visual template may show an occupied seat section that is not obstructed by anything, and the image of the ROI 408 may show an empty seat section that is partially obstructed by a foreground object such as a light pole. The augmentation server 122 may modify the selected visual template (e.g., by adding an image of a light pole).

The original content item 401 may comprise an activity with a small audience (e.g., a soccer game taking place in a stadium where in one or more seat sections are partially occupied by a small number of real soccer fans). The ROI(s) 408 may comprise one or more seat sections that are not completely empty but are partially occupied by the real soccer fans. The augmentation server 122 may add the visual effects 419 to the empty part(s) of the seat sections in the ROI(s) 408 while maintaining images of the real soccer fans in the ROI(s) 408. For example, the visual effects 419 may comprise one or more of past images/videos of past audiences, images/videos provided by remote audiences (e.g., via online video sessions), computer-generated characters, or any other video/image content. The augmentation server 122 may simulate interactions between the real soccer fans and the simulated audience represented by the visual effects 419.

The visual effects 419 may comprise additional video/image content. The additional video/image content may comprise one or more of advertising content (e.g., an image of an advisement), content associated with the activity and/or event information indicated in the metadata 403 of the original content item 401 (e.g., an image of “Go Team A!”), and/or any other video/image content that may be presented to users. The advertisements may be determined based on a user's geographical location, a type of content of the content item, and/or any other information associated with the user and/or the content item.

The visual effects 419 may comprise the selected visual template with or without modification. The modified video frame 418 may be generated by adding the visual effects 419 to the ROI 408, of the video frame 414, to simulate the audience appearance for the video frame 414. The modified video content 417 may comprise the modified video frame 418 and one or more additional modified video frames. As such, during the video modification 402, the augmentation server 122 may generate the modified video content 417 by adding a simulated audience to the original video content 413. In some examples, a series of different images may be associated with a visual template (and/or with a series of visual templates) so that the added visual effects will simulate movement. For example, if a series of video frames show an empty seat section while a player is preparing to take a shot, slightly different images of a standing/waving audience may be added to ROIs in successive video frames so that the added visual effects may present movement of an audience.

During the audio modification 404, the augmentation server 122 may add the sound effects 429 to the original audio content 423 to simulate audience sounds. The augmentation server 122 may determine the original audio content 423 from the original content item 401. The sound effects 429 may comprise sound recordings from past activities, computer generated sounds, sounds provided by users via online video sessions, or any other audio content.

The sound effects 429 may comprise event sound effects 428 and/or background sound effects 430. The event sound effects 428 may simulate audience sounds associated with one or more event 451. The background sound effects 430 may simulate background noise made by an audience and that is not associated with an event.

The event sound effects 428 may be added to a portion of the original audio content corresponding to an event time interval 454 associated with the event 451. The event 451 may be associated with a timestamp 453 indicating a time point (or a time period) at which the event occurs.

Even though the event 451 takes place at the timestamp 453, historical data may indicate that, based on past similar events of similar activities with audiences, an audience response to an event may extend before and/or after a time of a particular event associated with the timestamp 453. The audience response may, for example, have previously extended over an event time interval 454. The time length of the event time interval 454 may vary based on the estimated excitement level associated with the event 451 and/or based on other information (e.g., game time remaining, weather, etc.) associated with the event 451. For example, an event associated with a higher estimated excitement level may be associated with a longer event time interval than an event associated with a lower estimated excitement level. As another example, a last-minute goal may be associated with a longer event time interval than a goal made in the middle of the game. Still as another example, a goal made in a sunny warm day may be associated with a longer event time interval than a goal made in a rain cold day.

The event time interval 454 may surround the timestamp 453, and may comprise a pre-event time interval 455 immediately preceding the timestamp 453 and/or a post-event time interval 457 immediately following the timestamp 453. An audience may, for example, normally start responding to an event during the pre-event time interval 455 before an event similar to the event 451 actually occurs, and may continue to respond to that event for the post-event time interval 457. For example, in a soccer game without a live audience, a goal may occur at 01:05:02. Historical data may indicate that, during past goals in past soccer games with live audiences, audiences started responding to past goals an average time of 5 seconds before the past goals actually took place, and continued to celebrate after the past goals for an average time period of 1 minute. In this example, the pre-event time interval 455 may be 5 seconds, and the post-event time interval 457 may be 1 minute.

The time length of the pre-event time interval 455 and the time length of the post-event time interval 457 may vary based on the estimated excitement level associated with the event 451 and/or based on other information (e.g., player popularity, event type, etc.) associated with the event 451. For example, a goal made by a more popular soccer player may have a longer pre-event interval than a goal made a less popular soccer player. This may be because an audience may get excited sooner for an attempt for a goal by the more popular soccer player than for an attempt for a goal by the less popular soccer player. As another example, a red card in a soccer game may have a longer post-event time interval 457 compared to a yellow card. This may be because an audience may stay excited longer for the red card that is more likely to impact the game results than a yellow card.

Some events may be associated with only one of the pre-event time interval and the post-event time interval. An example may be a joke in a stand-up comedy. If the historical data indicates that an audience laughs at the joke only after the joke is told, the joke may be only associated with a post-event time interval.

During an event time interval determination 425, the augmentation server 122 may determine the event time interval 454, for the event 451, based on information included in the metadata 403 and/or historical data. For example, the metadata 403 may indicate the timestamp 453 (e.g., 01:05:02), a type of the activity (e.g., a soccer game), a type of the event 451 (e.g., a goal), identification of the player making the goal (e.g., player 4 of Team 1), stadium information (e.g., Team 1's home stadium), team information (e.g., between Team 1 and Team 2), etc. The augmentation server 122 may analyze the history data, and determine that for past goals made by Team 1 in the past soccer games between Team 1 and Team 2 in the Team 1 's home stadium, audiences started to respond to the past goals an average time of 5 seconds before the past goals actually took place and the live audiences continued to celebrate the past goals for an average period of 1 minute after the past goals. The augmentation server 122 may determine that the pre-event interval 455 may be 5 seconds, and the post-event interval 457 may be 1 minute. The event time interval 454 may be the sum of the pre-event time interval 455 and the post-event time interval 457, and may be 1 minute and 5 seconds. The event time interval 454 may extend from 01:04:57 (5 second prior to the timestamp 453) to 01:06:02 (1 minute after the timestamp 453).

Alternatively or in addition, the content server 106 may predetermine the event time interval 454, the pre-event time interval 455, and/or the post-event time interval 457 for the event 451, and/or may include corresponding information about the predetermined time intervals in the metadata 403. The augmentation server 122 may determine the information about the predetermined time intervals from the metadata 403 and determine the event time interval 454, the pre-event time interval 455, and the post-event time interval 457 based on the determined information.

The augmentation server 122 may add the event sound effects 428 to the portion, of the original audio content 423, corresponding to the event time interval 454. The event sound effects 428 may be determined based on estimation of reaction (e.g., by or otherwise associated with an audience) associated with the event 451. The template database 431 may comprise one or more event audio templates. The event audio templates may comprise sound recordings from past activities, computer-generated soundtracks, soundtracks provided by users via an online video session, or any other audio content. The augmentation server 122 may select one or more highlight audio templates for simulating the audience sound in response to the highlight 451. For example, the augmentation server 122 may select an event audio template that may best simulate audience sounds for the event 451, modify the selected event audio template if applicable, and add the selected event sound template (with or without modification) to the portion, of the original audio content 423, corresponding to the event time interval 454.

For example, an event audio template may comprise a sound recording associated with a past event of a past activity, and the sound recording may comprise audio content representing past audience sounds in response to the past event. The event audio template may be associated with information for the past activity and the past event (e.g., the type of past event, the excitement level of the past event, the stadium location of the past activity, etc.), a time length of the recording, and/or any other information (e.g., sound volume) of the sound recording.

The metadata 403 may indicate activity information and event information associated with the event 451 (e.g., the type of event 451, the estimated excitement level for the event 451, the stadium location of the current activity, the event time interval 454, etc.), and/or any other information about the event 451 and/or the content item 401. Similar to the selection of a visual template as described above, the augmentation server 122 may compare information associated with the event 451 to information associated with the event audio templates, and may select a matched and/or best (e.g., closest approximate match) event audio template. Selection of an event audio template may be similar to the selection of a visual template as described above. For example, the augmentation server 122 may select the event audio template that is associated with an excitement level closest to the estimated excitement level for the event 451.

Alternatively or in addition, the augmentation server 122 may prioritize information included in the metadata 403 (e.g., the activity and event information associated with the event 451), and select an event audio template based on a priority order of the information. For example, the augmentation server 122 may narrow a pool of event audio templates based on all the information included in the metadata 403 in a priority order, until a matched or a best (e.g., closest match) event audio template is found.

Alternatively or in addition, each type of the information associated with an event audio template may be assigned a weight, and each type of the information associated with an event audio template may be compared to the corresponding type of information of the event 451. Based on the corresponding weight and similarity of each type of the information between the event audio template and the event 451, a weighted sum may be determined for the event audio template. The weighted sum may predict how well the event audio template may simulate the audience sounds if used for determining an event audio template. The augmentation server 122 may select the event audio template having the highest weighted sum for simulation.

Similar to the modification of the selected visual template described above, before being added to the original audio content 423, the selected event audio template may be modified to improve the quality of the augmented content item 481. For example, the excitement level of the selected event audio template may be lower than the estimated excitement level for the event 451. Since an audience may make louder sounds for more exciting events, to match the higher estimated excitement level for the event 451, the augmentation server 122 may modify the selected event audio template by increasing volume of the selected event audio template. As another example, if the time length of the selected event audio template is shorter than the event time interval 454, one or more portions of the selected event audio template may be repeated to cover the entire event time interval 454.

As another example, if the selected audio template is associated with different activity location information compared to the event 451, the augmentation server 122 may identify (e.g., by sound recognition) audio presenting audience sounds of singing celebration songs that are traditional in the geographical area associated with the selected audio template, and may replace the identified audio with audio presenting audience sounds of singing celebration songs that are traditional in the geographical area associated with the event 451.

As another example, if the selected audio template is associated with different activity participant information compared to the event 451, the augmentation server 122 may modify the selected audio template to add sound effects proper for the activity participant information associated with the event 451. For example, the event 451 may be a goal made by Team A, but the selected audio template may comprise audio representing audience sounds of cheering “Go Team B.” The augmentation server 122 may identify (e.g., by sound recognition) the audio representing the audience sounds of cheering “Go Team B” included in the selected audio template, and replace the identified audio with audio presenting audience sounds of cheering “Go Team A.”

The background sound effects 430 may be added to simulate background noise made by an audience (e.g., during times when there is no event). For example, even if there is no event, sports fans may still talk to each other, sports fans may seek help from stadium employees, etc. Any of these activities may generate background sounds during the sporting match. The augmentation server 122 may add the background sound effects 430 to the extracted original audio content 423 to simulate the background sounds generated by these audience activities.

The background sound effects 430 may be added to an entirety of the original audio content 423. Alternatively, the background sound effects 430 may be added to one or more portions of the original audio content 423 not associated with events. The one or more portions of the original audio content 423 may be outside of one or more event time intervals 454. Addition of the background sound effects 430 may be similar to addition of the event sound effects 428 as described above.

For example, the template database 431 may comprise one or more background audio templates (e.g., sound recordings past activates when there was no event, or any other type of audio) and information associated with those background audio templates. The augmentation server 122 may compare information included in the metadata 403 to the information associated with the background audio templates, and may select one or more of the background audio templates for simulating the background noise.

For example, the information of a background audio template may comprise type of a past activity, level of the past activity, a time length of background sound recording, and/or any other information of the past background sound recording. The metadata 403 may comprise information of the event associated with the original content item 401, e.g., activity type, activity level, content time length, etc. The augmentation server 122 may compare the information associated with the original content item 401 to the information associated with the background audio template determine a matching and/or a similarity score. A background audio template may be selected based on a matching or a similarity score, for example, using any method of selecting an event audio template described above.

Similar to the modification of the selected event audio template as described above, the selected background audio template may be modified before being added to the original audio content 423. For example, if the selected background audio template is associated with a sunny day while the original content item 401 is associated with a rainy day, audio data to simulate the sound of falling rain may be added to the selected background audio template.

As described above, during the audio modification 404, the augmentation server 122 may generate the modified audio content 427 by adding simulated audience sounds to the original audio content 423. The modified video content 417 and the modified audio content 427 may be synchronized so that video for events may be output at same time as corresponding audio for those events. The synchronized video content 417 and audio content 427 may be combined to generate an augmented content item 481. The augmented content item 481 may include the visual effects 419 and/or the sound effects 429 that simulate audience appearance and audience sounds, respectively.

As described above, the templates included in template database 431 may comprise past images captured during past activities and/or sound recordings from past activities. The template database 431 may collect the past images and/or sound recordings from past activities from users though a reward system. For example, the reward system may offer monetary incentives and/or non-monetary incentives (e.g., online game credits) to the users if the users upload their past images, videos, and/or sound recordings.

The template database 431 and/or another computing device may analyze past videos and audios, select representational images and sound recordings as templates, and/or store these templates in the template database 431. For example, if the template database 431 determines to select ten visual templates to represent different events in a soccer game, the template database 431 may determine to choose an image showing an audience reaction to a game start, an image showing an audience reaction to a game end, an image showing an audience reaction to a beginning of the second half, an image showing an audience reaction to a middle-game goal, an image showing an audience reaction to a last-minute goal, an image showing an audience reaction to a yellow card, an image showing an audience reaction to a red card, an image showing an audience reaction to a missed goal, an image showing an audience reaction to passing, and/or an image showing an audience reaction to a penalty kick. The template database 431 may assign a corresponding excitement level to each image based on the excitement level of the corresponding event. The template database 431 may store the selected ten images as the visual templates. The template database 431, and/or one or more other computing devices performing any of the above-described operations associated with the template database 431, may be located in a local office (e.g., the local office 103) and/or in the external network 109.

Even though FIG. 4 shows that both of the visual effects 419 and the sound effects 429 are added to the original content item 401 during the augmentation, there may content items for which only one of visual effects and sound effects are added. For example, an original content item may be specifically targeted to hearing impaired users and may only comprise video content. Because that original content item only includes video content, visual effects may be added and sound effects may be omitted. As another example, an original content item may comprise a radio program and may only comprise the audio content. Because that original content item only includes audio content, the sound effects 429 may be added and visual effects may be omitted. Even if an original content item comprises both original video content and original audio content 423, one of visual effects and/or sound effects may be omitted. If, for example, the original content item is modified for broadcast via radio (e.g., without a video), sound effects may be added and visual effects may be omitted.

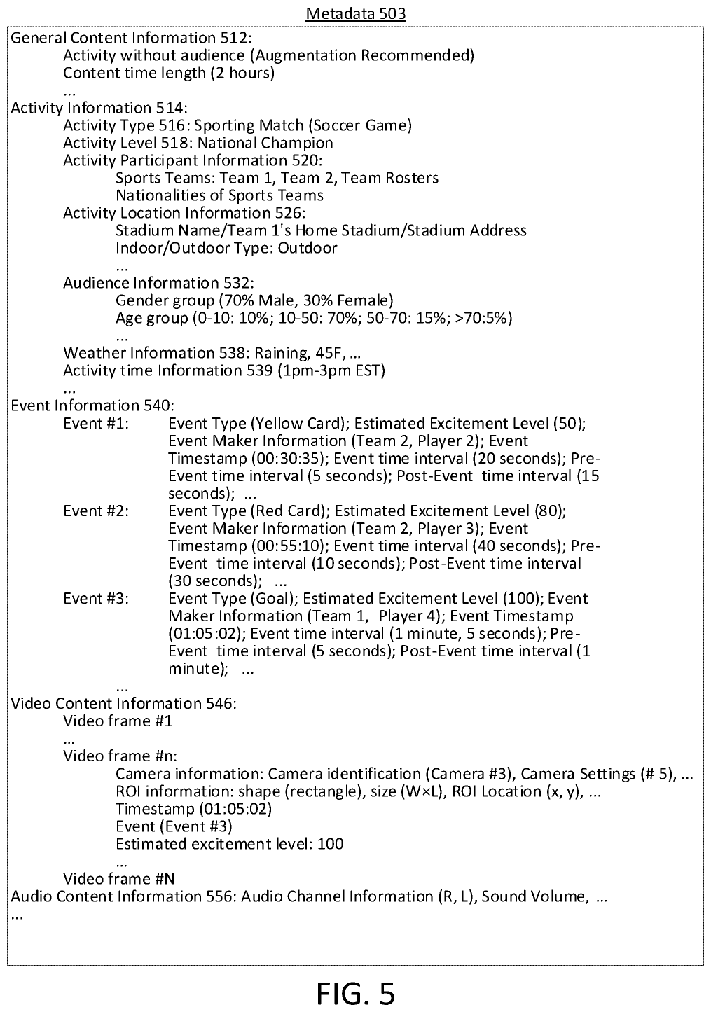

FIG. 5 shows an example of a metadata 503 that may be used to generate an augmented content item. The metadata 503 may be similar to the metadata 403. The metadata 503 may be associated with a content item such as, for example, the original content item 301 or the original content item 401. The metadata 503 may indicate any descriptive information for the content item. Any information indicated by the metadata 503 may be used to generate an augmented content item such as, for example, the augmented content item 481. For example, the content item may comprise a video stream of an activity, and the activity may comprise one or more events. The metadata 503 for the content item may comprise one or more of general content information 512, activity information 514, event information 540, video content information 546, audio content information 556, or any other information related to the content item.

The general content information 512 may indicate that the activity takes place without a live audience and/or that augmentation is recommended and/or otherwise appropriate for the content item. If the augmentation server 122 determines that the metadata 503 includes such an indication, the augmentation server 122 may add visual effects and/or sound effects to the content item. If the augmentation server 122 determines that the metadata 503 does not include such an indication or otherwise includes an indication that an augmentation is not recommended, the augmentation server 122 may not add visual effects and/or sound effects to the content item.

The general content information 512 may indicate a content time length of the content item. For example, if the content item comprises an activity that lasts 2 hours, the general content information 512 may indicate that the content time length of the content item is 2 hours. The time length of audio content of the content item and/or the time length of video content of the content item may be the same as the content item time length.

The general content information 512 may comprise any other general information associated with the content item. For example, the general content information 512 may comprise an address (not shown) of the content server 106 to indicate an address of the source of the content item, a file size of the content item, a video resolution, an audio resolution, etc.

The activity information 514 may comprise any information about the activity associated with the content item. For example, the activity information 514 may comprise an activity type 516, an activity level 518, activity participant information 520, activity location information 526, audience information 532, weather information 538, activity time information 539, and/or any other information associated with the activity.

The content item may comprise coverage of a sporting match, a video game such as an electronic sporting match, an on-stage performance, news, or any other type of activity. The activity type 516 may indicate a type of the activity associated with the content item. For example, the activity type 516 may indicate that the content item comprises a sporting match. The activity type 516 may be more specific. For example, the event type 516 may indicate that the content item comprises a soccer game.

The activity level 518 may indicate importance of the activity, popularity of the activity, scale of the activity, influence of the activity, etc. For example, the event level 518 may indicate that the sporting match is a national championship game. As another example, the activity level 518 may indicate that the sporting match is a local match.

The activity participant information 520 may identify participants in the activity and/or indicate information about the participants. For example, the activity participant information 520 may indicate that the soccer game is between Team 1 and Team 2, may indicate the team rosters of Team 1 and/or Team 2, nationalities of Team 1 and/or Team 2, and/or any other information associated with the participants.

The activity location information 526 may indicate information about where the activity takes place. For example, the activity location information 526 may indicate the stadium name of the stadium in which in the soccer game takes place, may indicate home stadium information if applicable, and/or may indicate the stadium address. The activity location information 526 may also indicate whether the stadium is an indoor stadium or an outdoor stadium. In FIG. 5, the activity location information 526 may indicate that the stadium is Team 1's home stadium and is an outdoor stadium.

The audience information 532 may indicate information about the audience of the activity. For example, since the activity takes place without a live audience, the audience information 532 may be estimated audience information determined based on historical data. For example, if the historical data indicates that past soccer games between Team 1 and Team 2 at Team 1's home stadium have an average gender group of 70% of male and 30% of female, and an average age group including 10% of ages 0-10, 70% of ages 10-50, 15% of ages 50-70, and 5% of >ages 70, the audience information 532 may indicate those gender and age group percentages.

The weather information 538 may indicate the weather during the activity. For example, the weather information 538 may indicate that when the activity takes place, it is raining and the temperature is 45 F.

The activity time 539 may indicate the time of a day when the activity takes place. For example, if the activity takes place from 1 μm to 3 μm Eastern time, the activity time 539 may indicate 1 μm-3 μm (EST).

If the activity comprises one or more events, the event information 540 may indicate any information about the one or more events. For example, the event information 540 may indicate that the activity comprises one or more events (e.g., event #1, event #2, event #3, etc.), and may indicate information associated with each event. The event information 540 may comprise an event type (e.g., yellow card, red card, goal, etc.), an estimated excitement level, event maker information (e.g., information about person(s) who cause or are otherwise associated with the event), an event timestamp (e.g., information about the time when the event occurs), an event time interval, a pre-event time interval, a post-event time interval, and/or any other information associated with the event. Different events may have different estimated excitement levels, different event time intervals, different pre-event time intervals, and different post-event time intervals. Information regarding event time intervals, pre-event time intervals, and/or post-event time intervals may be omitted (e.g., if such intervals are determined by an augmentation server based on the metadata 503 and historical data).

Video content of the content item may comprise a sequence of video frames (e.g., video frame #1, video frame #2, video frame #3, . . . video frame #n, . . . video frame #N), wherein n is any number between 1 to N. For a video frame, the video content information 546 may indicate camera information (e.g., information about the stadium camera capturing the image of the corresponding video frame, the camera settings of the camera during capture of the image of the video frame, etc.); ROI information (e.g., shape, size, and ROI location of one or more ROIs of the video frame that require visual effects); a timestamp indicating the time, in the activity, at which the scene represented by the video frame occurs; an estimated excitement level associated with the video frame; and/or any other information associated with the video frame.

FIG. 5 shows, as part of the video content information 546, information associated with the video frame #n. For example, the camera information may indicate that the camera generating the image of the video frame #n is stadium camera #3, and the camera #3 is configured at camera settings #5 when the camera #3 captures the image of the video frame #n. The ROI information may indicate that the video frame #n has an ROI which is a rectangle having a sizes of (W×L), and has a coordinate of (x, y) assuming that the left bottom corner of the video frame #n is the origin. If a video frame does not have an ROI, the metadata 501 may comprise an indicator (e.g., “no ROI”) indicating that the video frame does not have a ROI.

For example, the video content information 546 may indicate that the video frame #n presents a scene that occurs at 01:05:02 of the soccer game. Because the timestamp of the video frame #n is the same as the timestamp of the event #3, the video content information 546 may also indicate that the video frame #n is associated with the event #3. Because the video frame #n presents a scene of the event #3, the video content information 546 may also indicate that the estimated excitement level for the video frame #n is same as the estimated exited level of the event #3, which is 100.

The audio content information 546 may include audio information (e.g., audio channel, sound volume, etc.) of the content item. For example, the audio content information 556 may indicate that the content item has two audio channels (e.g., a left channel, a right channel). The audio content information 556 may indicate that sound volume for each audio channel.

If any of the above information is unavailable, the metadata 501 may include an indicator (e.g., N/A) to indicate such information is unavailable. For example, if the content server 106 does not predetermine an estimated excitement level for an event or a video frame, the metadata may put an indicator of “N/A” in the estimated excitement level for the event and the estimated excitement level for the video frame. If the metadata includes an indicator of “N/A” in the estimated excitement level, the augmentation server 122 may determine the estimated excitement level based on other information included in the metadata 503. Information included in the metadata 503 is not limited to the information described above. Any additional information about the content item may be included in the metadata 503.

Any of the information included in the metadata 503 may be used in connection with simulation of audience images and/or audience sounds for the content item. With regard to the activity type 512, for example, audiences associated with different types of activities may look different and/or may make different types of sounds. In a sporting match, an audience may wear sports team colors to show support and/or may generate cheering and/or booing sounds. In a stand-up comedy show, an audience may wear casual clothes and/or may generate laughing sounds. The augmentation server 122 may select visual template(s) and/or audio template(s) (e.g., event audio template(s), background audio template(s)) associated with a same or similar activity type as the content item.

With regard to the activity level 518, for example, a higher level sporting match (e.g., a national championship game) may attract a larger and/or more vocal audience than a lower level sporting match (e.g., a local match). The augmentation server 122 may select visual template(s) and/or audio template(s) associated with a same or similar activity level as the content item.

With regard to the activity participant information 520, for example, a sporting match between two more popular teams may attract a larger and/or more vocal audience than a sporting match between two less popular teams. The augmentation server 122 may select visual template(s) and/or audio(s) template associated with same or similar popular sports teams.

As another example, the nationalities of sports teams may affect determination of visual template(s) and/or audio template(s). Sports fans having same nationalities as the participating teams may be more likely watch a sporting match at a stadium. People from certain countries may have certain traditions that have distinct visual and/or sound characteristics to celebrate a goal or other event (e.g., dancing, singing, etc.). The augmentation server 122 may select visual template(s) and/or audio template(s) associated with same or similar nationalities of one or more of the sports teams.

With regard to the activity location information 526, for example, different stadiums may have different lightings, different camera arrangements, different seat section arrangements, different sound systems, etc. As another example, audiences in a certain geographic location may celebrate events by making certain body movements (e.g., doing certain traditional dance moves, waving arms in certain traditional ways, etc.) and/or making certain sounds (e.g., singing certain traditional songs). The augmentation server 122 may select visual template(s) and/or audio template(s) associated with a same or similar activity location (e.g., a same or similar stadium) as the content item.

As another example, whether the stadium is indoor or outdoor may affect determination of visual template(s) and/or audio template(s). Audience sounds generated in an outdoor stadium may have more echoes than audience sounds generated in in an indoor stadium. Because an outdoor stadium may have different lightings compared to an indoor stadium, an audience may appear differently in the outdoor stadium than in the indoor stadium. The augmentation server 122 may select visual template(s) and/or audio template(s) associated with a same or similar indoor/outdoor type as the content item.

With regard to the audience information 532, for example, an audience including more males than females may appear and/or sound differently compared to an audience including more females than males (e.g., wearing attire in different colors and/or styles, making sounds having different average sound frequencies, etc.). Similarly, audiences having different age groups may appear differently and/or sound differently. The augmentation server 122 may select visual template(s) and/or audio template(s) associated with a same or similar gender and/or age group as the content item.

With regard to the weather information 538, for example, audiences may appear and sound differently in different weather. An audience may wear jerseys and make more intense sounds in a sunny warm day, and an audience may wear raincoats and make less intense sounds in a raining cold winter day. The augmentation server 122 may select visual template(s) and/or audio template(s) associated with same or similar weather as the content item.

With regard to the activity time information 539, for example, an audience may appear more energetic and more responsive to events (e.g., making louder sounds and making more exaggerated body movements) in the morning than in the afternoon. The augmentation server 122 may select visual template(s) and/or audio template(s) associated with a same or similar activity time as the content item.

With regard to the event information 540, for example, an audience may respond to different types of events by making different types of sounds, making different facial expressions, making different body movements, etc. The audience may make cheering sounds for a goal (e.g., the event #3), and may make booing sounds for a red card (e.g., the event #2). The augmentation server 122 may select visual template(s) and/or audio template(s) associated with a same or similar event type as the content item.

As another example, the estimated excitement level for the event may affect determination of visual template(s) and/or audio template(s). An audience may respond differently to events associated with different excitement levels. An audience may make more exaggerated body movements and louder sounds for a last minute goal than for a goal made in the middle of a game. The augmentation server 122 may select visual template(s) and/or audio template(s) associated with a same or similar estimated excitement level as the content item.

As another example, the event maker information may affect determination of visual template(s) and/or audio template(s). An audience may react differently to events made (e.g., caused) by different persons. A goal made by a more popular player may receive louder cheers than a goal made by a less popular player, and may cause more sports fans to leave their seats to celebrate the goal made by the more popular player. The augmentation server 122 may select visual template(s) and/or audio template(s) associated with an event maker with same or similar popularity as the content item.

As another example, the event timestamp of the event may affect determination of visual template(s) and/or audio template(s). A last minute goal may trigger louder cheers than a goal occurring in the middle of the game, and may cause more sports fans to leave their seats to celebrate the last minute goal. The augmentation server 122 may select visual template(s) and/or audio template(s) associated with a same or similar timestamp of the event as the content item.

With regard to the video content information 546, for example, selection of an audio template may be based on the camera information. Visual templates may comprise past images, for examples, captured during past activities. The augmentation server 122 may select a visual template comprising a past image captured by the same camera with same camera setting as the video frame #n, because the selected visual template may have the same point of view as the video frame #n.

Selection of an audio template may be based on the camera information. Audio templates may comprise sound recordings, for example, from past activities. A sound recording may be associated with camera identification and camera setting to indicate where the sound represented by the sound recording came from. For example, a sound recording may represent sounds generated from a left side of the stadium (e.g., relative to a particular camera) and/or may correspond to one or more images which may represent the left side of the stadium. The one or more images representing the left side of the stadium may be associated with camera information of the camera(s). The sound recording may be associated with the camera information of the one or more images representing the left side of the stadium to indicate that the sounds in the sound recording came from the left side of the stadium. When adding sound effects for an event, the augmentation server 122 may select an audio template comprising a sound recording associated with the same camera information as one or more video frames representing the event. For example, the one or more video frames representing the event may include image(s) representing the left side of the stadium. The augmentation server 122 may select an audio template comprising a sound recording that has the same camera information as the one or more video frames. The selected audio template may represent sounds generated from the left side of the stadium. As such, when the user sees the left side of the stadium on the display of the user device, the use may hear the sounds from the left side of the stadium. Such consistency between what the user sees and what the hears may improve the user viewing experience.

As another example, the resolution of the video frame may affect determination of visual template(s). For example, the augmentation server 122 may select the visual template having the same or similar resolution as the video frame #n to insert into the ROI of the video frame #n, so that the modified video frame may have consistent resolution.

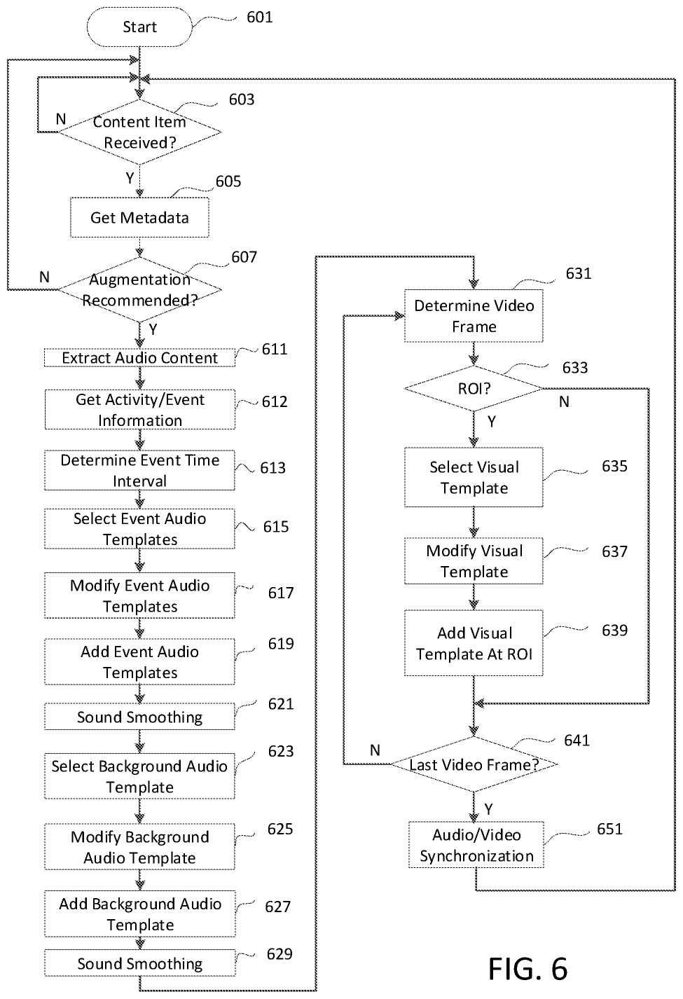

FIG. 6 is a flow chart showing an example method for generating an augmented content item. Although the description of FIG. 6 will assume for convenience that steps of the example method are performed by the augmentation server 122, the steps of the example method may also or alternatively be performed by a user device with which a user consumes a content item, and/or by any other computing device. Steps of the example method of FIG. 6 may be omitted, performed in other orders, and/or otherwise modified, and/or one or more additional steps may be added.

The method may start from step 601 at which the augmentation server 122 may be initialized. For example, the augmentation server 122 may be powered up. At step 603, the augmentation server 122 may determine if a content item is received. If no content item is received, step 603 may be repeated. If a content item is received, metadata associated with the received content item may be received or otherwise obtained at step 605. The metadata may be similar to the metadata 403, 503 described above.

As described above, the general content information 512 included in the metadata 503 may indicate that augmentation is appropriate for the content item. Based on the general content information 512, the augmentation server 122 may at step 607 determine if the content item will be augmented. If it is determined that the content item will be augmented, step 603 may be repeated and the augmentation server 122 may continue to determine if a new content item is received.

If it is determined that the content item will be augmented, step 611 may be performed. At step 611, the audio content may be extracted from the received content item. At step 612, the augmentation server 122 may determine, based on the metadata, activity information (e.g., activity type, activity level, activity participant information, activity location information, audience information, weather information, activity time information, etc.), event information (e.g., event type, estimated excitement level, event maker information, event timestamp, etc.), and/or other information associated with the received content item.

At step 613, the augmentation server 122 may determine portions of the extracted audio content to which event sound effects may be added. The portions may correspond to event time intervals of events of the received content item. The augmentation server 122 may determine event time intervals based on the event information and/or other information. For example, the augment server 122 may determine that a last-minute goal may be associated with a longer event time interval than a goal made in the middle of the game. The augmentation server 122 may determine that an event associated with a higher estimated excitement level may be associated with a longer event time interval than an event associated with a lower estimated excitement level. The augment server 122 may determine that a red card is associated with a longer event time interval than a yellow card. The augmentation server 122 may determine that a goal made by a more popular soccer player may have a longer event interval than a goal made by a less popular soccer player.

Alternatively or in addition, the augmentation server 122 may determine the event time interval based on activity information and/or other information from the metadata. For example, the augmentation server 122 may determine that a goal made in a sunny warm day may be associated with a longer event time interval than a goal made in a rain cold day. The augmentation server 122 may determine that a goal made in the morning may be associated with a longer time interval than a goal made in the afternoon (e.g., because an audience may be more energetic in the morning). The augmentation server 122 may determine that a goal made in a home stadium may be associated with a longer event time interval than a goal made in other stadiums. The augmentation server 122 may determine that a goal made in a national championship game may be associated with a longer event time interval than a goal made in a regular season game. The augmentation server 122 may determine that a goal occurring in a game between two more popular teams may be associated with a longer event time interval than a goal occurring in a game between two less popular teams. The augmentation server 122 may determine that scoring in a football game (e.g., a touch down) may be associated with a longer event time interval than scoring in a basketball game (e.g., a basketball player putting the ball thought the basket), for example, because scoring in a football game may be rarer than scoring in a basketball game. The augmentation server 122 may determine that a goal made in a game associated with an estimated audience having an estimated age group including 70% of ages 10-50 may be associated with a longer event time interval than a goal made in a game associated with an estimated audience having an estimated age group including 70% of ages >70.

The augmentation server 122 may determine that the event time interval comprises a pre-event time interval prior to the event timestamp and a post-event time interval following the event timestamp. As described above, the pre-event time interval and the post-event time may vary based on activity information, event information, and/or other information associated with the received content item.

If the content server 106 predetermines the event time intervals for the events of the received content item and includes corresponding information about the predetermined event time intervals in the metadata, the augmentation server 122 may at step 613 also or alternatively determine an event time interval based on that corresponding information. For example, the augmentation server 122 may determine event time intervals, for events #1-#3 in FIG. 5, based on information about the predetermined event time intervals included in the metadata 503. For the event #1, the event time interval may have a time length of 20 seconds, and the event time interval may start at 00:30:30 (5 seconds prior to 00:30:35) and end at 00:30:50 (15 seconds after 00:30:35). Similarly, for the event #2, the event time interval may start at 00:55:00 (10 seconds prior to 00:55:10) and end at 00:55:40 (30 seconds after 00:55:10), and for the event #3, the event time interval may start at 01:04:57 (5 seconds prior to 01:05:02) and end at 01:06:02 (1 minute after 01:05:02).

The augmentation server 122 may determine the event sound effects to be added to the audio content portions determined in step 615. For example, at step 615, the augmentation server 122 may select one or more event audio templates, stored in the template database 431, that may best simulate audience sounds during a event. As described above, selection of an event audio template may depend on information included in the metadata.

One or more of the methods described above with respect to the selection of an event audio template may be used in step 615. For example, the plurality of event audio templates may comprise sound recordings from past activities. A selection may be based on the event type and excitement level. For the event #1 associated with a yellow card and an estimated excitement level 50, the augmentation server 122 may select an event audio template comprising a sound recording associated with a yellow card and an excitement level of 50. For the event #2 associated with a red card and an estimated excitement level 80, the augmentation server 122 may select an event audio template comprising a sound recording associated with a red card and an excitement level of 80. For the event #3 associated with a goal and an estimated excitement level 100, the augmentation server 122 may select an event audio template comprising a sound recording associated with a goal and an excitement level of 100.

At step 617, the selected event audio templates may be modified. Any method described above with respect to the modification of an event audio template may be used in step 617. For example, the modification may be based on information included in the metadata. For example, the metadata may indicate that the current activity may take place in an outdoor stadium, but the selected event audio template may be associated with an indoor stadium. The augmentation server 122 may reduce echo in the selected event audio template such that the simulated audience sound is more like outdoor sound. As another example, the metadata may indicate that the current activity may take place on a windy and rainy day, but the selected event audio template may be associated with a sunny day. Sound effects for rain and/or wind may be added to the selected event audio template.

At step 619, the event audio templates (as modified, if modification was performed) may be added into corresponding portions of the extracted audio content. For example, the event audio template for event #1 may be added to a portion of the extracted audio content corresponding to 00:30:30-00:30:50 in the activity, the event audio template for event #2 may be added to a portion of the extracted audio content corresponding to 00:55:00-00:55:40 in the activity, and the event audio template for event #3 may be added to a portion of the extracted audio content corresponding to 01:04:57-01:06:02 in the activity.

At step 621, sound smoothing may be used to avoid sudden artifacts during transitions between the original audio content to the added event audio templates. For example, crossfading may be applied to the adjunction(s) between the original audio content and the added event audio templates for a smooth transition. If two selected event audio templates are added to two adjacent portions of the original audio content, crossfading may be also applied to the adjunction between the two event audio templates.

The augmentation server 122 may add background sound effects for the received content item to the extracted audio content. For example, a background audio template may be selected based on the metadata (step 623), the selected background audio template may be modified (step 625), the modified background audio template may be added to one or more portions of the extracted audio content (step 627), and sound smoothing may be applied for smooth sound transitions (step 629). Any method described above with respect to selection and/or addition of the background sound effects may be used in steps 623-629.

The augmentation server 122 may add visual effects for the received content item. The visual effects may be added to one or more video frames included in the received content item. At step 631, the augmentation server 122 may determine a video frame (e.g., the video frame #n in FIG. 5) of the content item. At step 633, the augmentation server 122 may process the determined video frame to determine if the video frame has an ROI. Any method described above with respect to determining the ROI for a video frame may be used in step 633. For example, the augmentation server 122 may determine the ROI based on the metadata. If the metadata indicates that the video frame does not have an ROI, step 641 may be performed. Step 641 is described below. If the metadata indicates that the video frame has an ROI, the augmentation server 122 may in step 635 select a visual template from the template database 431. Any method described above with respect to selection of a visual template for a video frame may be used in step 635. For example, the selection may be based on information included in the metadata. For example, if the metadata indicates that the video frame is associated with a goal in a soccer game and is associated with an estimated excitement level of 100 (e.g., as shown for video frame #n in FIG. 5 based on the references to Event #3), the augmentation server 122 may select a visual template that is associated with a goal in a soccer game and has an excitement level of 100.

At step 637, the augmentation server 122 may modify the selected visual template. Any method described above with respect to modification of a visual template may be used in step 637. For example, the modification may be based on information included in the metadata. For example, the metadata may indicate that the video frame is associated with an outdoor stadium, but the selected visual template may be associated with an indoor stadium. The augmentation server 122 may apply lighting effects to the selected visual template to simulate natural light.

Optionally, steps 633-637 (e.g., determining ROI, selecting visual template, and modifying visual template) may be performed only for independent video frames (e.g., I-frames). The augmentation server 122 may use the same visual template associated with an I-frame to modify the corresponding dependent video frames (e.g., B-frame, P-frame, etc.) that are associated with the I-frame.

At step 639, the augmentation server 122 may add the visual template (as modified, if modification is performed) into the ROI by replacing or covering the ROI of the video frame. In step 641, the augmentation server 122 may determine if the video frame, determined in the most recent performance of step 631, is the last video frame for processing. If the video frame is the not last video frame, step 631 may be repeated and a next video frame determined. If the video frame is the last video frame, the augmentation server 122 may at step 651 synchronize and combine the modified video content and the modified audio content. Step 603 may be repeated to determine if an additional content item is received for processing, and if so, additional steps of the method may be repeated. Augmentation of a content item may be customized based on a user's preferences. For example, a user may send a user request for a simulated audience having a particular gender group or age group. Based on such a user request, the content server 106 may update information of gender group or age group included in metadata. As another example, a user may send a user request for simulated audience images having a particular image resolution and/or simulated audience sounds having a particular audio resolution. Based on such a user request, the content server 106 may update the metadata by adding information of the requested resolution(s). The augmentation server 122 may select a visual and/audio template based on the requested resolution(s) and/or modify a selected visual and/audio template based on the requested resolution(s). Any information in the metadata may be customized and updated based on user preferences.

A received content item may be an immersive video stream of immersive video content for virtual reality (VR) presentations. Such immersive video content may, for example, be viewed and/or heard via a computing device such as a VR headset. During viewing, the user may turn his or her head to view different areas of the immersive video content, and the user may only look at a portion of a video frame at a time. The portion that the user is viewing may be the user's field of view. The audio content of the immersive video stream may comprise object based audio that is associated with virtual locations of objects shown in the immersive video content. If the user is viewing objects within the user's field of view, the audio content representing the sounds from the objects within the user's field of view may be delivered to the VR headset. If the immersive video content comprises a sporting match without a live audience, the augmentation server 122 may perform video modification (similar to the video modification 402) and/or audio modification (similar to the audio modification 404) to add visual effects (similar to the visual effects 419) and sound effects (similar to the sound effects 429) to the immersive video content, respectively.

During the video modification, for example, the VR headset may monitor the user's field of view and send the information of the user's field of view to the content server 106 and/or the augmentation server 122. Based on the information of the user's field of view, the content server 106 and/or the augmentation server 122 may determine the ROI(s) (similar to the ROI(s) 408) for the portion of the video frame that corresponds to user's field of view, and add the visual effects to the ROI(s) within the user's field of view. Alternatively or in addition, the content server 106 and/or the augmentation server 122 may determine the ROIs for the entire video frame, and the augmentation server 122 add visual effects to the ROI(s) for the entire video frame.

During the audio modification, for example, the sound effects 429 may depend on the user's field of view. The augmentation server 122 may add sound effects to the audio content representing the sounds from the objects within the user's field of view. The audio content may comprise left audio channel content and right audio channel content. If the user's field of view indicates that the user turns his head to the left, the volume of the sound effects for the left audio channel content may be increased.

Also or alternatively, the sound effects may depend on prediction of where an audience may sit in a stadium. For example, sports fans supporting the same team may sit together in a designated seating region. If a goal is made by a that team, the audience sound may be generated from that designated seating region. For example, historical data may indicate that for a soccer game between Team 1 and Team 2 at Team 1's home stadium, most of the fans supporting Team 1 may sit on the left side of the stadium. If a goal is made by Team 1, most of cheering sound may come from the left side of the stadium. Accordingly, when adding the sound effects for the goal, the volume of the sound effects for the left audio channel content may be increased.

As indicated above, steps of the example method of FIG. 6 may be omitted, performed in other orders, and/or otherwise modified, and/or one or more additional steps may be added. For example, steps 611-629 may be performed after steps 631-641 or may be performed in parallel with steps 631-641. As another example, step 629 may be omitted if the background audio template is a single sound recording from a past activity that covers an entirety of the extracted audio content. As a further example, addition of event and/or background audio templates may be performed iteratively in a manner similar to as described for addition of visual templates (e.g., by sequentially detecting and processing portions of original content item audio).

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
determining, by a computing device, a time of an event in a content item;
determining, based on information associated with the event, a time interval comprising one or more of:
a time interval before the time of the event, or
a time interval after the time of the event; and
outputting an augmented version of the content item that comprises augmented audio content corresponding to the time interval.

2. The method of claim 1, wherein the information associated with the event comprises one or more of:
a content type associated with the content item,
a level associated with the content item,
participant information associated with content item,
location information associated with content item,
audience information,
weather information,
time information associated with content item,
an event type of the event,
an estimated excitement level associated with the event, or
information associated with one or more persons causing the event.

3. The method of claim 1, wherein the augmented version of the content item comprises audio effects added to a portion of the content item corresponding to the time interval, and
the audio effects comprise one or more of: audience sounds or weather sounds.

4. The method of claim 1, wherein the augmented version of the content item comprises augmented video content comprising video effects, the method further comprising:
determining, based on metadata associated with the content item, a region of interest of a video frame of the content item; and
adding, based on the information associated with the event, the video effects to a portion of the video frame corresponding to the region of interest.

5. The method of claim 1, wherein the information associated with the event comprises one or more values indicating an estimated level of audience reaction to the event, and the augmented version of the content item comprises audio effects, added to a portion of the content item corresponding to the time interval, based on the estimated level of audience reaction.

6. The method of claim 1, further comprising:
adding, based on the information associated with the event, audio effects to one or more portions, of the content item, outside of a portion, of the content item, corresponding to the time interval.

7. The method of claim 1, wherein the information associated with the event comprises a first estimated excitement level associated with the event, the method further comprising:
determining, based on metadata associated with the content item and for a second event in the content item, a second estimated excitement level higher than the first estimated excitement level; and
determining, based on the second estimated excitement level and for the second event, a second time interval that is longer than the time interval.

8. The method of claim 1, wherein the augmented version of the content item comprises audio effects added to a portion of the content item corresponding to the time interval, and the method further comprising:
selecting, from a database and based on the information associated with the event, a first audio template; and
determining the audio effects based on the first audio template.

9. The method of claim 1, wherein the augmented version of the content item comprises audio effects added to a portion of the content item corresponding to the time interval, and the information associated with the event comprises an estimated excitement level associated with the event, the method further comprising:
determining a difference between an excitement level, associated with audio determined based on the information associated with the event, and the estimated excitement level associated with the event; and
based determining the difference, generating the audio effects by increasing a volume of the audio.

10. The method of claim 1, wherein the time of the event is based on metadata associated with the content item.

11. A method comprising:
determining, by a computing device and based on information associated with an event in a content item, a time interval associated with the content item;
determining, based on the information associated with the event, one or more audio templates; and
outputting an augmented version of the content item that comprises augmented audio content, corresponding to the time interval, that is based on an audio template of the one or more audio templates.

12. The method of claim 11, wherein the augmented version of the content item comprises audio effects, added to a portion of the content item corresponding to the time interval, based on modified audio associated with the audio template.

13. The method of claim 11, wherein the information associated with the event comprises one or more of:
a content type associated with the content item,
a level associated with the content item,
participant information associated with the content item,
location information associated with the content item,
audience information,
weather information,
event time information,
an event type of the event,
an estimated excitement level associated with the event, or
information associated with one or more persons causing the event.

14. The method of claim 11, wherein the augmented version of the content item comprises audio effects, added to a portion of the content item corresponding to the time interval, that comprises one or more of: audience sounds or weather sounds.

15. The method of claim 11, wherein the augmented version of the content item comprises augmented video content, the method further comprising:
determining, based on metadata associated with the content item, a region of interest of a video frame of the content item; and
generating the augmented video content by adding, based on the information associated with the event, video effects to a portion of the video frame corresponding to the region of interest.

16. The method of claim 11, wherein the augmented version of the content item comprises augmented video content comprising video effects, the method further comprising:
determining a video template based on the information associated with the event; and
adding, based on the information associated with the event and on the video template, the video effects to the content item.

17. The method of claim 11, further comprising:
determining, based on metadata associated with the content item and for the event, a time in the content item,
wherein the time interval comprises one or more of:
a time interval preceding the time in the content item, or
a time interval following the time in the content item.

18. A method comprising:
determining, by a computing device, for an event in an activity associated with a content item, and based on information associated with the event, one or more audio templates and one or more video templates; and
outputting an augmented version, of the content item, that comprises:
augmented audio content comprising audio effects, corresponding to the event, based on an audio template of the one or more audio templates, and
augmented video content comprising video effects, corresponding to the event, based on a video template of the one or more video templates.

19. The method of claim 18, wherein the information associated with the event comprises one or more of:
a content type associated with the content item,
a level associated with the content item,
participant information associated with the content item,
location information associated with the content item,
audience information,
weather information,
time information associated with the content item,
an event type of the event,
an estimated excitement level associated with the event, or
information associated with one or more persons causing the event.

20. The method of claim 18, wherein the audio template comprises a sound recording that was recorded for a past activity, or
wherein the video template comprises a video that was captured for a past activity.
